(19) United States
(12) Patent Application Publication
(10) Pub. No.: US 2010/0182710 A1
(43) Pub. Date: Jul. 22, 2010

(54) METHOD FOR PRODUCING AN OPTICAL ELEMENT THROUGH A MOLDING PROCESS, OPTICAL ELEMENT PRODUCED ACCORDING TO THE METHOD, COLLECTOR, AND LIGHTING SYSTEM

(75) Inventors: Udo DINGER, Oberkochen (DE); Ulrich Bingel, Michelfeld (DE); Jeffrey Erxmeyer, Oberkochen (DE); Eral Erzin, Koenigsbronn (DE); Bernhard Weigl, Steinheim (DE); Stephane Bruynooghe, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 12/626,437

(22) Filed: Nov. 25, 2009

Related U.S. Application Data
(63) Continuation of application No. PCT/EP2008/004273, filed on May 29, 2008.
(60) Provisional application No. 60/932,517, filed on May 31, 2007.

(30) Foreign Application Priority Data
May 31, 2007 (DE) 10 2007 025 278.3

(51) Int. Cl. G02B 7/192; C25D 1/06; B23P 17/00; G02B 5/08

(52) U.S. Cl. 359/883; 205/71; 29/424

(57) ABSTRACT

A method for producing an optical element or part of an optical element having a base body, including:—providing a mold body (21, 1000, 2000) which has a surface corresponding to the geometry of the optical element;—depositing a layer system (7) including at least one separation layer system (15, 1010, 2010) on the surface of the mold body (21, 1000, 2000);—electroforming a base body (4, 1030, 2030) on the layer system (7); and—detaching at least the base body from the mold body (21, 1000, 2000) at the separation layer system (15, 1010, 2010).

This is a Continuation of International Application PCT/EP2008/004273, with an international filing date of May 29, 2008, which was published under PCT Article 21(2) in German, and the complete disclosure of which, including amendments, is incorporated into this application by reference.

### FIELD OF AND BACKGROUND OF THE INVENTION

The invention relates to a method for the production of an optical element by molding, an optical produced according to a method of this type, a collector shell, in particular for a grazing-incidence collector for use, in particular, with EUV radiation in the wavelength range of 4 nm to 30 nm and preferably 7 nm to 15 nm. The invention also relates to a microlithography projection illumination system, and in particular an illumination system for a microlithography projection illumination system.

Optical elements, for example, for microlithography systems have conventionally been produced on prefabricated substrates, for example, by means of vapor-deposition methods. This is described, for example, in DE 10 2005 017 742 A1. In the method according to DE 10 2005 017 742 A1, at least the optically active coating is deposited on a substrate. Methods of this type are, firstly, very complex and, secondly, unsuitable for coating, for example, closed surfaces.

Optical surfaces which are configured closed are found, for example, in collectors. See U.S. Pat. No. 7,244,954 in this regard.

A disadvantage of the systems, for example, from DE 10 2005 017 742 A1 was that the substrates were non-conductors which were able to become electrostatically charged, for example, on installation in an illumination system.

Collectors for illumination systems with a wavelength preferably ≦126 nm, in particular preferably wavelengths in the EUV region from 4 nm to 30 nm and particularly at 7 nm or 13.5 nm for collecting the light radiated from a light source and for illuminating a region in a plane with a plurality of mirror shells which have rotational symmetry and arranged within one another about a common rotation axis, are known in a plurality of embodiments.

U.S. Pat. No. 5,763,930 discloses a nested collector for a pinch-plasma light source which serves to collect radiation emitted from the light source and to bundle it into a light guide.

U.S. Pat. No. 6,285,737 B1 discloses an illumination system comprising a grazing-incidence collector mirror. The collector mirror comprises a plurality of individual mirrors in a stacked arrangement. The individual mirror surfaces of the stack do not form a coherent surface and particularly not a closed surface such as a surface of revolution. A surface of revolution is a surface formed by revolution about a rotation axis of a curve which lies in one plane which includes the rotation axis.

The individual mirrors of the stacked mirror array according to U.S. Pat. no. 6,285,737 B1 comprise a base layer which forms the base body and is coated with a reflective layer made, for example, from rhodium, molybdenum, gold or an alloy. Preferably, the individual mirror is coated with ruthenium. The application of the individual layers onto the base body is carried out with a vapor-deposition or sputtering method, i.e., with conventional methods. The thickness of the metal layer forming the reflector layer is very great, in particular over 100 nm to make it resistant to the thermal influences brought about by the arrangement in relation to the light source. Following vapor-deposition, the layer is optically polished. The mirror shells thereby formed either have flat, elliptical or aspherical surfaces. The ruthenium-coated individual mirrors reflect 50%-84% of the EUV radiation when the angle of incidence is between 75° and 80° to the surface normal, i.e., when the mirror is operated with grazing incidence.

As an alternative to the collector system made from an array with stacked individual mirrors, as described in U.S. Pat. No. 6,285,737, collectors with closed surfaces, such as surfaces of revolution, can be used in illumination systems for EUV lithography. Collectors of this type have become known, for example, from U.S. Pat. No. 7,091,505, US-2003-0043455 A1, U.S. Pat. No. 7,015,489, US 2005/023645 A1, US 2006-0097202 A1 or EP 1225481.

The collectors with closed mirror shells described in the cited documents are preferably configured as systems with a plurality of closed mirror shells arranged within one another and are designated “nested collectors.” Closed mirror shells are, for example, annular closed mirror surfaces.

### OBJECTS AND SUMMARY OF THE INVENTION

The collector shells which are configured as closed surfaces, for example, as surfaces of revolution, either have the disadvantage of low reflectivity of the incident light or are unstable and tend to deform under thermal loading as occurs, in particular, in EUV systems.

It is therefore an object of the present invention, in a first aspect, to provide a method which overcomes the disadvantages of the prior art.

According to one formulation the invention, this is achieved with a method for the production of an optical element comprising:
providing a mold body with a surface which essentially corresponds to the geometry of the optical element;
depositing a layer system comprising at least one separation layer system on the surface of the mold body;
electroforming a base body on the layer system, in particular using an electrochemical process; and
detaching the layer system and the base body at the separation layer system from the mold body.

In the above described molding process, a distinction can be made between, firstly, production methods with direct molding of the entire optical element, for example, the collector shell with a mold body and, secondly, the spatially and temporally separated possible molding of the base body with subsequent coating. Both methods offer the advantage that the optical element, for example, the collector shell, is already present as a structural unit following the molding process. The optical element, for example, the collector shells, are effectively made from inside out. For this purpose, a mold body with a surface which essentially matches the geometry of the optical element, for example, the collector shell, is provided for both methods. A layer system comprising, in the first method, at least one separation layer system and a reflector layer system is deposited thereon and, in the second method, a separation layer system is deposited without a reflector layer system. The base body is formed on the layer system by electroforming, in particular an electrochemical process. Thereafter, the optical element, for example, the collector shell on the separation layer system, is detached from the mold body. While in the second method an evaporation step for the reflector layer system follows, in the first method the optical element, for example, the collector shell, has already been made.

The difficulty of the molding process consists in finding a suitable separation layer system which permits molding without influencing the optimal optical properties of the reflector layer (in the first method) while preserving the mechanical stability of the individual layers.

Coating layers that are used are, for example, PVD (Physical Vapour Deposition), e.g., thermal evaporation, evaporation with electron beam evaporators or sputtering, in particular sputtering with magnetron sources.

In the case of thermal evaporation and evaporation using electron beam evaporators, the evaporation source is positioned below the mold body to be coated. A sufficiently even layer thickness can be achieved, firstly, by providing a large distance between the source and the mold body and, secondly, by simultaneous evaporation using a plurality of evenly arranged sources.

When sputter technology is used, the sources must be arranged at equal distances close to the surface of the mold body to be coated due to the high sputter gas pressure necessary with this method. Optimum layer thickness homogeneity can be achieved with a sputter source which matches the form of the mold body, in particular a magnetron source.

Vapor-coating of the surface of the mold body to be coated facing away from the deposition source can be performed, for example, by rotating the mold body during the coating procedure.

Subsequent coating of previously molded optical elements, for example, collector shells with the reflector layer system is carried out, in the case of sputtering, as stated above, with a plurality of sources arranged at equal distances or with one source adapted to the form of the mold body. On use of thermal sources or electron beam evaporators, the use of shutter techniques enables an even layer distribution over the entire surface of the optical element.

For an optimum molding process, it is necessary to keep the layer tension of the overall layer system with a base layer as small as possible, so that no layer cracks or layer detachments can occur. This is made possible both by the use of an ion-supported vapor-deposition process and through optimization of coating parameters such as layer thicknesses or vapor-deposition rates in conjunction with the rotation of the mold body during coating, since the layer tensions are highly dependent thereon.

A molded layer system according to the invention for producing optical elements, for example, collector shells for grazing-incidence collectors, which comprises the entirety made up from the mold body, separation layer system, layer system and the base layer forming the base body before molding, i.e., separation, is characterized in the first embodiment of an optical element according to the invention, in particular a collector shell, by the sequence of mold body and layers of silicon dioxide SiO₂, gold Au and, for example, in the case of collectors, ruthenium Ru, nickel Ni galvanized. The second alternative embodiment of the optical element, for example, the collector shell, is characterized by a sequence of mold body and layers of SiO₂, Ru, Cr, Ru, Cr, Ni and galvanized Ni in the case of a grazing-incidence collector.

Apart from the production of optical elements wherein the light is reflected at an oblique angle of incidence, that is, under grazing incidence, it is also possible with the method according to the invention to produce optical elements which reflect the radiation incident on the optical element at normal incidence, also known as “normal-incidence optical elements.”

Grazing-incidence reflection is preferably understood to mean a reflection where the reflection angle is more than 70° to the normal which is perpendicular to the reflecting surface.

Normal-incidence reflection is preferably understood to mean a reflection where the reflection angle is less than 30° to the normal which is perpendicular to the reflecting surface.

If the optical element which is produced using the described molding technique is a normal-incidence optical element, for example a normal-incidence mirror, in a particular embodiment, the mirror surface has a multiple-layer system, for example, an alternating layer system made from alternating Mo/Be layers or alternating Mo/Si layers. Preferably, layered systems of this type comprise more than 40 and more preferably, more than 60 such alternating layers.

When light meets a surface coated with a multiple-layered alternating layer system of this type, the incident light is reflected essentially under normal-incidence, that is at angles <30° to the surface normal.

Optical elements which are operated at normal-incidence can be normal-incidence collector mirrors or, in particular, faceted mirrors or pupil faceted mirrors as known from U.S. Pat. No. 6,658,084 B2 or US 2006/0 132 747 A1. A faceted optical element, for example, a field faceted mirror, can comprise 72 facets, as disclosed in U.S. Pat. No. 6,658,084, which are applied to a mirror support or a substrate. Each individual mirror facet then acts as a normal-incidence mirror.

In the first case, of a molding process, the separation layer system comprises an SiO₂ layer deposited on the mold body and an Au layer deposited on the SiO₂. The detachment of the optical element, for example, the collector shell, from the mold body is performed using an additional Au layer between the SiO₂ surface and the Au surface in the separation layer system. In a further method step, Au is detached from the reflector layer, preferably chemically.

In the second case of a molding process, the separation is carried out directly between the layer system of the collector shell and SiO₂. In order to reduce the adhesion forces, particularly between the layer system, comprising, for example, a ruthenium layer or an Mo/Si multiple-layer system and the SiO₂ layer, a conditioning step is provided. In this layer, the SiO₂ layer is subjected, after deposition thereof, to surface treatment over a defined duration. The layer system is then directly deposited on the SiO₂ layer. Preferably, in grazing-incidence systems, layers of ruthenium and an adhesion layer of chromium can be deposited alternately. In systems of this type, the separation takes place between the SiO₂ surface and the Ru surface.

In both cases, the optical element is effectively produced from inside out. Production from inside out has the advantage, for example, that collector shells with closed surfaces and with small diameters, preferably diameters d≦200 mm, can be produced. A further advantage, particularly with normal-incidence faceted mirrors, is easier production. With a method of this type, merely a mold body which can be used to produce a plurality of faceted mirrors needs to be made, and the surface of said mold body very precisely processed and used for a plurality of molding operations, whereas in a method according to the prior art, every individual set of faceted mirrors must be laboriously polished.

According to a further embodiment, the optical element can also be produced by molding the base body and subsequent coating. In this case also, a mold body which has a surface which corresponds to the geometry of the optical element is provided. If the optical element is a collector shell, the surface corresponds to the inner wall of the base body. The base body is molded on the mold body, preferably by an electrochemical process. The base body is subsequently detached from the mold body. The deposition of a layer system is subsequently performed temporally offset and using different equipment. The system comprises at least one reflector layer which is applied to the surface of the base body. This is also carried out by thermal vapor-deposition, electron beam evaporation or sputtering.

A molded layer system, for example, for the production of collector shells by molding the base body and subsequent coating is characterized by the sequence: mold body, layers of silicon dioxide SiO₂ and gold Au or palladium Pd as the separation layer system. Ruthenium Ru can be subsequently vapor-deposited thereon.

For faceted optical elements, a series of mold bodies made from layers of SiO₂, gold (Au) or palladium (Pd) can be provided as a separation layer system and an Mo/Si or Mo/Be multiple-coating system. Where sputter techniques are used, the coating of the reflector layer system comprising at least one Ru layer or an Mo/Si or Mo/Be multiple-layer system is carried out, as set out above, using a plurality of sources arranged at an equal distance, or with one source matched to the shape of the mold body. On use of thermal sources or electron beam evaporators, the inner surface of the collector shell is subsequently coated with Ru using shutter techniques.

A collector shell is preferably used in a grazing-incidence collector. In an advantageous embodiment, a collector comprises not only one single shell with rotational symmetry or shell of revolution, but a plurality of such collector shells with rotational symmetry, wherein the shells of revolution are arranged within one another about a common rotational axis. The collector is configured with at least two collector shells, and preferably four, six, eight or ten collector shells arranged within one another. This is a component of an illumination system for the EUV wavelength region wherein the optical rays are incident at an angle of greater than 70° to the surface normal. In such a case, this is known as a grazing-incidence collector. Grazing-incidence collectors have the advantage, compared with normal-incidence collectors, that they become degraded by the debris of the source only to a small extent, i.e., they hardly lose any reflectivity. Grazing-incidence collectors are also always more simply constructed, since they usually only have one optical coating. Reflectivity values >80% can be achieved with these without making great demands regarding the surface roughness.

In addition to the above-described production of a collector shell as a grazing-incidence element, the production of a normal-incidence element, for example, a faceted mirror or an imaging mirror or a normal-incidence collector mirror, will now be described in greater detail. If an optical element of this type is made using molding technology, then a mold body is initially made from a suitable material, for example, quartz glass or Kanigenized aluminum, and then super-polished. The super-polishing reduces the surface roughness of the mold body, or pattern body, also designated a mandrel, to values corresponding to those needed by a normal-incidence optical element coated according to conventional technology with multiple-layer systems, in order to have a high reflectivity in the region of 70% at a wavelength, for example, of 13 nm or 11 nm.

Preferably, such roughness values lie in the region of 0.2 nm HSFR. The roughness HSFR (High Spatial Frequency Roughness) denotes the RMS roughness at spatial frequencies in the range of 10 nm to several μm.

Following super-polishing of the mold body, the mold body is provided with a coating. A coating of this type can be, for example, a gold layer of between 50 nm and 200 nm thickness.

In a first embodiment of the invention a metal layer, for example, a nickel or copper layer, is allowed to grow on the 50 nm to 200 nm-thick conductive gold layer with the aid of a galvanic method. The gold layer serves therein as the cathode.

Then, with the aid of thermoseparation, the gold layer with the galvanically deposited metal layer thereon, for example the nickel layer, is separated and an Mo/Si multiple-layer with an Ru cover layer is allowed to grow on this separated layer.

Alternatively, in place of the subsequent growing-on of the multiple-layer systems, the production of a facet or of a normal-incidence element can also be carried out with molding techniques in that an Ru layer is applied to the mandrel and a multiple-layer system of Mo/Si is applied to the Ru layer.

It is only onto the grown-on multiple-layer system of Mo/Si and possibly a metal layer of, for example Au, which functions as a cathode, that the substrate layer of, for example, nickel Ni or copper Cu is galvanically grown.

Preferably, the last layer of the multiple-layer system is a conductive Mo layer which can serve as the cathode in a method of this type. For this purpose, the Mo layer can be applied correspondingly thickly. Alternatively, it is also possible to apply a metal layer of, for example, gold Au, nickel Ni or ruthenium Ru, wherein this metal layer serves as the cathode.

With the method according to the invention for producing normal-incidence optical elements, advantageously, cooling channels or cooling conduits can be introduced into the galvanically applied substrate layer of the optical element with the aid of the molding method, during galvanic deposition of the substrate support. These cooling conduits serve to conduct away the large amount of absorbed heat energy, which can amount to between 3 W and 5 W per facet with a faceted element. Preferably, the cooling takes place with the aid of a fluid medium, for example, water. In order to galvanize the cooling elements into the substrate surface, initially an approximately 0.5 mm-thick metal layer of, for example, nickel or copper, is grown onto the metal layer connected to the mandrel. Following growing-on of a first part of the metal layer serving as the substrate layer, the cooling elements, in particular the cooling conduit, are then positioned. Once the cooling conduits have been positioned, metal is further deposited galvanically so that the cooling conduits are embedded into the substrate surface firmly and in material-fitting manner. Embedding the cooling conduit into the substrate layer ensures a lower resistance to thermal conduction.

The galvanic method enables the introduction not only of cooling conduits into the metal substrate, but possibly also of bearing elements.

As described above, the optical element or a part of the optical element is separated from the mandrel by a temperature shock. For this purpose, the entire unit of mandrel and optical element is subjected to a sudden temperature change, typically to a lower temperature. Since the mandrel and the materials of the grown-on optical element have different coefficients of thermal expansion, a separation occurs between the mandrel and the grown-on optical element or part of the optical element as soon as the thermally induced tensions exceed the adhesion tensions between the layers of the optical element and the mandrel.

A gold layer, for example, can be used as the separation layer, as described above, since the gold remains on the separated metal body which represents the substrate. Apart from gold, Ru can also be used as the separation layer, in particular with grazing-incidence components.

It is an object in another aspect of the invention, to provide a grazing-incidence component, for example a grazing-incidence mirror, preferably a grazing-incidence collector, in particular with closed surfaces having high reflectivity and good optical imaging properties together with high stability and small volume.

In particular, collectors are to be provided which are characterized by high stability.

In order to achieve high reflectivity, it is provided that the individual collector shells, which are preferably configured as annular closed mirror surfaces, for example, as surfaces of revolution, are provided with ruthenium as the reflector layer.

In order to ensure high stability, particularly when used in EUV illumination systems, the geometric dimensions of a collector shell are chosen so that the collector shell is characterized by a length l≧120 mm. If the collector shell is not a closed surface but is, for example, a partially perforated surface, then the place of the diameter is taken by the perpendicular distance (d/2) of the end point from a straight line along which the length of the collector shell is defined. The perpendicular distance d/2 is ≦375 mm, preferably <150 mm and more preferably <100 mm, particularly preferably <75 mm and more particularly preferably <50 mm. It is particularly preferable if the distance d/2 lies between 40 mm and 375 mm, while it is more preferably between 40 mm and 135 mm and most preferably between 40 mm and 75 mm.

Preferably, the collector shells according to the present invention are “shells of revolution.” Shells of revolution are shells which are obtained by rotating planar curves about a rotational axis wherein, both the rotational axis and the planar curve lie in one plane. Examples of shells of revolution are cylindrical shells, spherical shells and conical shells. In the case of cylindrical shells, the planar curve is a line parallel to the rotational axis, in the case of spherical shells, the curve is a semicircle with its center on the rotational axis and in the case of conical shells, it is a straight line which intersects the rotational axis. The variables that are taken as being characteristic for collector shells in the present application are their length l and their diameter d or half their diameter, i.e., their radius.

In the case of shells of revolution, the length l means the length of the planar curve from a start point to an end point therealong. As stated above, the collector shell has a start point and an end point seen in the longitudinal direction of the rotational axis. The start point is the point on the shell which is closest to the light source and the end point is the point on the shell which is arranged furthest from the light source. The distance between the light source and the start point is designated the starting distance. This distance is smaller than the distance of the end point from the light source seen in the longitudinal direction of the optical axis.

In the present application, the diameter d is defined as twice the distance of an end point on the end of the shell from the rotational axis; i.e., d=2·re, where d=diameter of the shell at the end point; re=radius of the shell at the end point.

The perpendicular distance of the start point from the rotational axis is also designated the first radius or ra and the distance of the end point is designated the second radius re.

In the present application, the diameter d is defined from the radius of the end point re.

If the collector shell is configured as a surface of revolution, the length (l) along the rotational axis ≧120 mm and the diameter d≦750 mm, in particular d≦300 mm, preferably ≦200 mm, more preferably ≦150 mm and most preferably ≦100 mm. Preferably, the diameters of the mirror shells are in the range of 80 mm to 750 mm, more preferably in the range of 80 mm to 270 mm, and most preferably in the range of 80 mm to 150 mm.

The inventors have found that particularly good imaging properties can be achieved with the coating comprising Ru on a metal base body. Due to the small diameter d of the individual mirror shells, where preferably d≦200 mm and is most preferably in the range of 80 mm to 270 mm, a high degree of stability is achieved. Furthermore, on use of a plurality of such shells arranged within one another to make a nested collector, a large collection aperture can be achieved with a small number of shells. Additionally, in a further-developed embodiment, a high level of efficiency is attained by selecting the minimum length l≧120 mm.

Due to the possible smaller diameter compared with the prior art collector shells described in U.S. Pat. No. 7,091,505 or U.S. Pat. No. 7,015,489, a good imaging result can be achieved even under severe thermal loading. If, with a collector with a plurality of shells, the diameter of the largest shell in the nested collector system is selected to be 200 mm and if the diameters of all the other shells are smaller, i.e., they are, for example, in the range of 80 mm to 200 mm, the deformation of the shells in the radial direction can be kept small, even under severe thermal loading. Since the deformation is small, there is hardly any influence on the imaging properties. At the same time, the collector shell has a high degree of stability.

During the production of optical elements using molding techniques, as described above using the example of closed mirror surfaces, in particular annular closed rotational surfaces, the surfaces can also be configured as non-closed surfaces, for example, as segments, without deviating from the invention.

Preferably, the collector shells comprise a base body, preferably made from a metal and a layer system arranged on the base body. The layer system comprises at least the reflector layer forming the optical surface. Preferably, the layer system according to a first embodiment comprises only the reflector layer.

The base body preferably comprises a metal, preferably galvanized nickel. Other possible materials for the base body are copper and ruthenium or a sequence of these materials and mixtures.

The thickness of the reflector layer made from ruthenium is preferably in the range of 10 nm to 150 nm, more preferably 10 nm to 120 nm, especially preferably 15 nm to 100 nm and most preferably between 20 nm and 80 nm. Apart from high reflectivity, this also achieves a high degree of stability with regard to deformation of the shell at low to moderate layer tension values.

According to a second embodiment, the layer system is configured as a multiple-layer system respectively comprising the components ruthenium and chromium arranged alternately in layers. In order to keep the layer tensions in the layer system as low as possible to avoid layer detachment, cracks and, under higher thermal loading, mechanical or chemical degradation, the coating parameters such as layer thickness, thickness ratios between the individual layers, vapor-deposition rates and other process parameters relating to the deposition, in particular the deposition of the individual layers, can be optimized and adjusted or controlled according to the desired result. These properties can also be influenced through the choice of the suitable process for applying or depositing the individual layers. The multiple-layer system is formed in detail with a first ruthenium layer foaming the optical layer, and a second ruthenium layer. An adhesion layer is provided between the first and second ruthenium layers. This is preferably made from chromium. Provided between the second ruthenium layer and the base body of the collector shell, in order to avoid layer detachment and unwanted reactions between the individual layers, in particular influencing of the ruthenium layers, is a metal intermediate layer which is preferably made from the same metal as the base layer forming the base body. if the base body is made from galvanized nickel, the intermediate layer is then preferably also made from nickel. The layer thickness of the nickel is preferably ≦30 nm.

Apart from an adhesive function, the adhesion layers have no further function, so that layer thicknesses in the range of 1 nm to 5 nm and preferably 1 nm to 2 nm can be considered sufficient. These layers are preferably formed from chromium. The layer thickness of the first ruthenium layer is in the range of 5 nm to 20 nm and preferably 8 nm to 12 nm. The second ruthenium layer is characterized by a layer thickness in the range of 20 nm to 80 nm, preferably between 30 nm and 60 nm.

The embodiments of the collector shell are characterized by a micro-roughness on the optical surfaces in the region of less than 2 nm RMS at a wavelength of 13 nm. The collector shells therefore have a sufficiently high reflectivity.

The collector shell is embodied geometrically as a shell of revolution, i.e., a body with rotational symmetry relative to a rotational axis. The collector shells are therefore closed surfaces. The rotational axis corresponds to the optical axis OA of the collector shell. Each individual collector shell is preferably configured as an aspherical segment with rotational symmetry about the rotational axis. It is particularly preferable if the mirror shells are shells of revolution of an ellipsoid, a paraboloid or a hyperboloid. For a paraboloid a completely parallel beam results, and therefore a light source at infinity.

Collectors with shells of revolution, the planar curves of which are sections of hyperboloids, lead to a divergent beam and are of particular interest if the collector is to be dimensioned as small as possible.

Particularly preferably, the inventive molding process is used with grazing-incidence components to provide cooling devices. For this purpose, on the conductive layer, for example, the 50 nm to 200 nm thick gold layer which was deposited onto the mold, that is the mandrel, initially a first layer of a metal, for example a nickel or copper layer, is deposited galvanically, wherein the gold layer serves as the cathode. Cooling and/or structural elements such as cooling conduits or bearing elements are then positioned on the surface of the grown-on metal layer. In a further method step, a further second layer of metal comprising nickel or copper is deposited galvanically such that the cooling and structural elements are firmly embedded into the substrate in material-fitting manner. In another method step, a further, second layer of metal comprising nickel or copper is deposited galvanically so that the cooling and structural elements are firmly embedded into the substrate in material-fitting manner. Thereby, cooling conduits needed for the optical elements, e.g., collectors, operated in grazing-incidence can easily be introduced into the substrate. Preferably, the first layer is between 0.1 mm and 1 mm thick and the second layer is between 1 mm and 4 mm thick.

In addition to grazing-incidence elements, it is also possible to produce normal-incidence elements with a method according to the invention.

A reflective normal-incidence element can be a mirror which is used, for example, in an imaging system such as a projection lens. Alternatively, such normal-incidence elements can also be normal-incidence collector mirrors.

Particularly preferably, a normal-incidence element comprises individual facets of a faceted optical element. Faceted optical elements with a plurality of individual facets, for example, field facets or pupil facets, are known from U.S. Pat. No. 7,006,595. The faceted optical element disclosed in U.S. Pat. No. 7,006,595 comprises, for example, 216 field facets and many pupil facets.

The disclosure of this application is included in its entirety in the present application.

The production of normal-incidence elements can also be carried out with the aid of a molding technique. For this purpose, a separation layer system is applied to a mold body. The separation layer system can be a metal layer, for example, an Au layer or an Ru layer, deposited on the mold body.

The base body of the reflective normal-incidence element can then be grown galvanically onto this layer and serves as the cathode.

Deposition of a metal onto the separation layer of, for example, nickel or copper by galvanic means can be carried out in two steps. In a first step, a first layer thickness in the range, for example, of 0.1 mm to 0.8 mm and preferably 0.5 mm of nickel or copper, can be deposited onto the gold layer applied to the mold body. Thereafter, structural elements or cooling elements that are to be introduced into the base body can be positioned.

In a second step, a second layer of metal, for example, nickel or copper, is deposited by galvanic means. The cooling conduits or bearing elements are therefore firmly introduced into the galvanically deposited base body in material-fitting manner. This ensures, in particular, a low resistance to thermal conduction. The galvanized-on base body can be separated from the mold body by a temperature shock. In a further step, a multiple-layer system for the reflective normal-incidence element, for example, comprising Mo/Si can then be applied to the separated base body.

Alternatively, it would also be possible to apply an Ru layer and, thereon, a multiple-layer system such as an Mo/Si multiple-layer system directly onto the mold body. The uppermost Mo layer would then serve as the electrode for galvanic deposition. For this purpose, it is possible for the uppermost Mo layer to be configured correspondingly thick. Alternatively or additionally, an electrode layer, for example, in the form of a metal layer such as a gold Au layer or a nickel Ni layer can be applied to the multiple-layer system.

When separation takes place, the entire normal-incidence element including the multiple-layer system deposited thereon can then be separated from the mold body.

The normal-incidence elements made according to the inventive method with the aid of molding techniques are characterized in particular by a base body comprising a metal such as nickel or copper and a separation layer arranged between the multiple-layer system and the base body, for example, comprising Au and a cover layer arranged over the multiple-layer system, for example, an Ru layer. Furthermore, mechanical components such as joint adaptors or cooling elements such as cooling tubes can very easily be introduced into the molded metal body.

### BRIEF DESCRIPTION OF THE DRAWINGS

The inventive solution will now be described in greater detail making reference to the drawings, in which:

FIG. 1 is a greatly simplified schematic representation of a first embodiment of an inventive grazing-incident element, in this case a collector shell;

FIGS. 2a-b are two further geometric embodiments of collector shells;

FIG. 3 is a second embodiment of a collector shell;

FIGS. 4a-b are schematically simplified illustrations of the structure of a deposition device and a molding layer system for the production of collector shells according to a first embodiment;

FIGS. 4c-d are flow diagrams of the molding process;

FIG. 5 is a diagram of the influence of the roughness on the detachment duration for the Au layer;

FIGS. 6a-b are illustrations of a molded layer system for collector shells according to a second embodiment before and after separation between the mold body and the shell;

FIG. 7 is an illustration of the deposition device for molding collector shells according to the second embodiment;

FIG. 8a-b are an illustration of a magnetron sputter system for producing the coating according to the first and second embodiments;

FIG. 9 is an illustration of a system for sputtering the reflector layer on the inside of the previously molded collector shell;

FIG. 10 is an illustration of a collector with collector shells embodied according to the invention, showing a section of an illumination system;

FIGS. 11a-c are graphical illustrations showing examples of possible characteristic values of roughness and reflection;

FIGS. 12a-g are a first possibility for producing normal-incidence elements with the aid of a molding method;

FIGS. 13a-h are a second possibility for producing normal-incidence elements with the aid of a molding method;

FIGS. 14a-h are a third possibility for producing normal-incidence elements with the aid of a molding method.

### DETAILED DESCRIPTION OF THE PREFERRED EMBODIMENTS

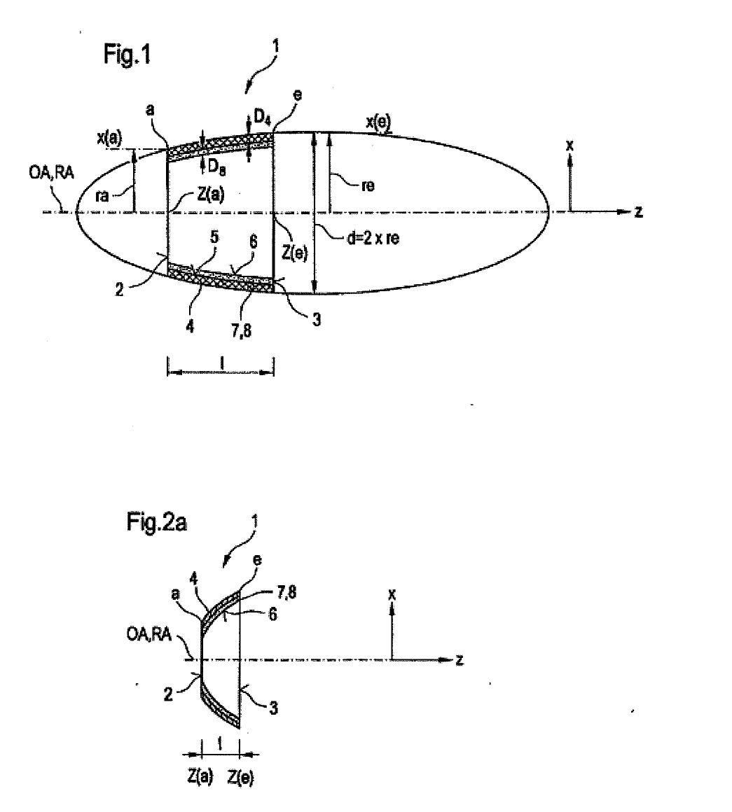

FIG. 1 shows, in a schematic simplified representation, the basic design of a first embodiment of a grazing-incidence element produced with the aid of molding techniques, for example, a collector shell 1, shown in a section in the z-x plane. This is configured as an element with rotational symmetry. The z-axis is defined by the optical axis OA, which corresponds to the rotational symmetry axis RA. The collector shell is formed as a shell of revolution by rotation of the curve K, which is planar in section in the z-x plane, about the rotational symmetry axis RA. The z-x plane which includes the rotational symmetry axis RA is designated the “meridional plane.”

The following reference signs are defined in the z-x coordinate system relative to the optical axis OA:
a start point
e end point
z(a) z-coordinate of the start point of the collector shell
z(e) z-coordinate of the end point of the collector shell
x(a) x-coordinate of the start point
x(e) x-coordinate of the end point

In the coordinate system, the start point a defines the first end region 2, also designated the object-side or input-side end region of the collector shell 1 and the end point b is designated the second end region 3, which is also designated the image-side or output-side end region of the individual collector shell 1 with respect to an arrangement in an illumination system, i.e., the start point is the point which, when the collector is in operation, is arranged in an illumination system in the light path closest to the light source and the end point is the point which is arranged furthest removed from the light source.

The distance between the optical axis OA and the start point a in the z-x coordinate system defines the radius ra of the first end region and the distance between the optical axis OA and the end point e defines the radius re of the second end region 3. The distance between the first and second end region in the z-direction determines the length l of the collector shell 1. The collector shell 1 configured according to the invention has a length l which defines the distance between the start point a and the end point e along the optical axis OA, which is preferably greater than 120 mm, more preferably lies in the range of 80 mm to 300 mm, in particular in the range of 150 mm to 200 mm. The maximum diameter, i.e., the diameter d(2·re) at the end point e of the collector shell 1 at the second end region 3 is ≦750 mm, preferably ≦200 mm, particularly preferably ≦150 mm and most preferably ≦100 mm. Preferably, the diameter d is in the range of 80 mm to 200 mm. re denotes the radius at the end of the shell, i.e., the distance of the end point on the shell surface from the rotational axis.

The collector shell 1 comprises a base body 4 which is configured with rotational symmetry relative to the axis OA, said base body also being designated as “shell of revolution” and having an optical surface 6 on the inner periphery 5 thereof. Said optical surface is a surface of the collector shell 1 which accepts an incident beam and reflects it in the direction of the image.

For this purpose, the base body 4 has a layer system 7 at the inner periphery 6 thereof, comprising at least one optically active layer in the form of a reflector layer 8. The reflector layer 8 preferably comprises ruthenium.

The collector shell 1 comprises at least the reflector layer 8 as the functional layer and at least one further layer which is designated the cover layer or underlayer and forms the base body 4. If the base body is made by molding techniques, the base body comprises a metal layer, for example, an Ni or Cu layer onto which a thin layer is applied. In this case, the layer system 7 is therefore characterized only by one thin layer. The layer thickness D8 of the reflector layer 8 is preferably up to 150 nm and particularly in the range of 10 nm to 120 nm, more preferably between 15 nm and 100 nm, most preferably between 20 nm and 80 nm, for example 50 nm. According to the first embodiment, the reflector layer 8 is directly applied as a layer on the inner periphery of the base body 4.

The base body 4 is characterized by a layer thickness D4 which is in the range of 0.2 mm to 5 mm and preferably 0.8 mm to 2 mm.

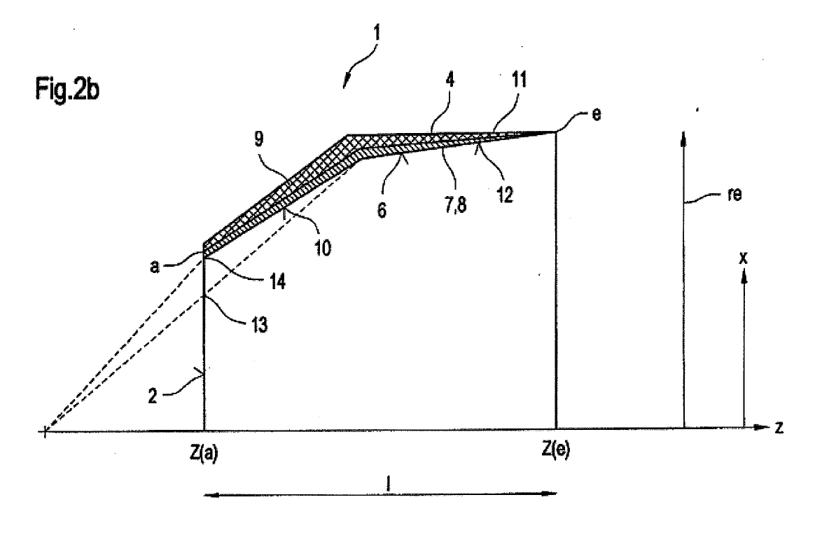

In the case shown, the collector shell 1 is configured as an ellipsoid segment. Other embodiments are disclosed, for example, in FIGS. 2a and 2b.

According to FIG. 2a, a collector shell 1 is configured as a paraboloid segment relative to the optical axis OA and thus the rotational symmetry axis RA. The basic structure also corresponds to that shown in FIG. 1, so that the same reference signs are used for similar elements.

FIG. 2b, by contrast, illustrates an embodiment of the collector shell 1 in the form of a combination of a hyperboloid and an ellipsoid. The geometry of the collector shell 1 is described by a first annular segment 9 with a first optical surface 10 and a second annular segment 11 with a second optical surface 12. The overall surface made from 10 and 12 corresponds to the optical surface 6.

Assigned to the collector shell 1 in each case is an inner edge ray 13 which is defined by the end point in the meridional plane of the first optical surface 10 of the first segment 9 of the collector shell 1, and an outer edge ray 14 which is defined by the start point of the first optical surface 10 of the first segment 9 of the collector shell 1. The inner and outer edge rays define the beam received and passed on by the shell.

The meridional plane is understood to be the plane which contains the optical axis or the rotational axis RA.

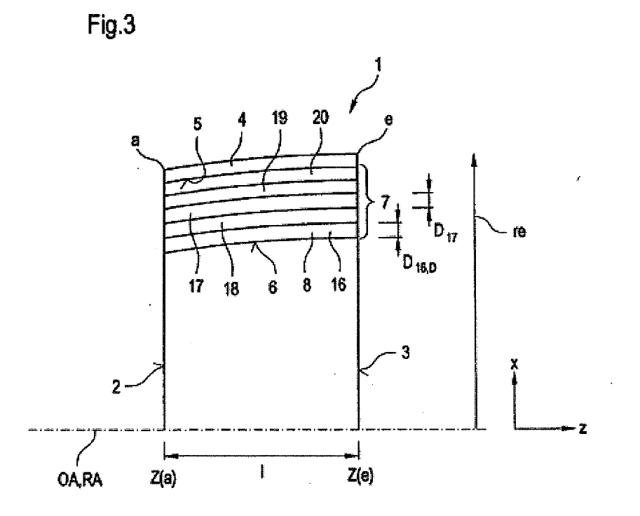

FIG. 3 illustrates in schematically simplified manner similar to FIG. 1, a further second embodiment of a collector shell 1 according to the invention with ruthenium as the reflector layer 8 with the dimensions according to the invention with regard to diameter and length l. Since the body has rotational symmetry relative to the z-axis, said body has been shown in an axial section only on one side. In this embodiment, the optical surface 6 is formed on the inner periphery 5 of the base body 4 by a layer system 7 in the form of a multiple-layer system. Said multiple-layer system comprises two ruthenium layers, a first ruthenium layer 16 and a second ruthenium layer 17, which are bound to one another via a first adhesion layer 18 and via a second adhesion layer 19 to the base body 4. The first ruthenium layer 16 is configured with a smaller layer thickness D16 than the second ruthenium layer 17. The layer thickness D16 is 5 nm to 20 nm, preferably 8 nm to 12 nm. The second layer thickness D17 is between 20 nm and 80 nm, preferably between 30 nm and 60 nm. The thickness of the individual adhesion layers 18 and 19 is between 1 nm and 5 nm in each case, preferably 1 nm to 3 nm.

In order to achieve optimum growth in the base layer which comprises the base body, an intermediate layer 20 is provided between the base layer and the optical layer system, preferably made from the material of the base layer, in this case nickel.

With regard to the possible embodiments regarding the geometry and molding of the optical surface 6, the possibilities shown in FIGS. 2a and 2b also exist for the first embodiment.

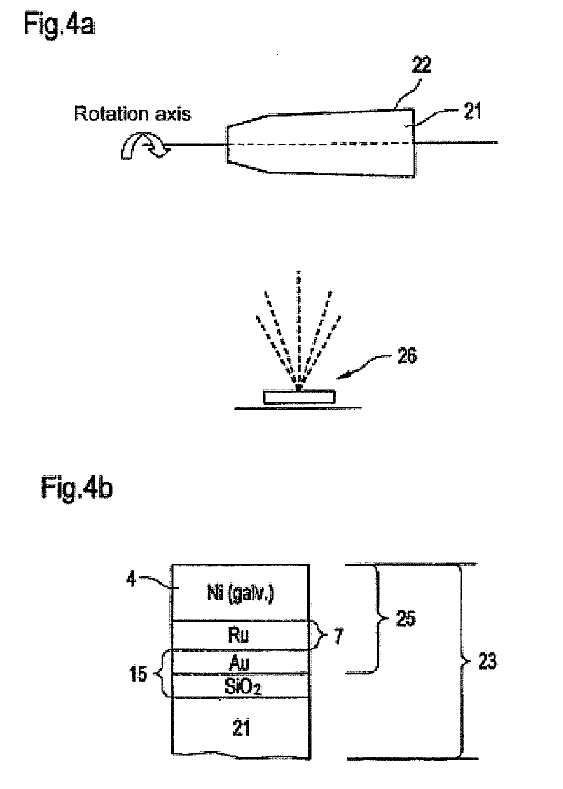

The production of the collector shell 1 according to the first or second embodiment is preferably performed by molding via a separation layer system 15. The molding method is shown in detail in FIGS. 4a-4b for a grazing-incidence element. The molding is carried out on a mold body 21 corresponding to the geometrical form of the collector shell 1, in particular a mold body 21 defining the inner wall. The molding takes place on the outer periphery 22 of the mold body 21, wherein the mold body 21 is either directly a component of the separation layer system 15 or is coated with the separation layer system, and wherein the reflector layer 8 for the grazing-incidence element is applied to the separation layer system 15. The mold body 21, the separation layer system 15 and the layer system 7 of the collector shell 1 comprise the molded layer system 23 before the molding. The mold body itself can comprise, for example, quartz glass, Ni-P or galvanized aluminum.

According to the invention, during molding the separation is carried out at the border surface between two materials, wherein one material preferably comprises SiO₂ and can either be applied directly from the mold body 21 or from a layer system (not shown) applied onto the mold body 21, wherein the layer system 24 can be applied to the mold body 21 temporally offset from the actual molding and remains thereon after separation or is applied in chronological sequence with the other components of the separation layer system 15 or the layer system 7 for the collector shell 1. The separation is based essentially on a temperature shock which leads to partially reduced tensions, which in turn lead thereto that the adhesion tension between the mold body and the separation layer system is overcome.

In order to produce the first embodiment of the collector shell 1 from the base body 4 and the reflector layer 8 arranged directly thereon as per FIG. 1, the separation takes place indirectly following completed molding, i.e., not directly between the reflector layer 8, or the layer system 7, and the mold body 21, but via a separation layer system 15 comprising, apart from the SiO₂ layer, an Au layer, wherein the separation takes place between the SiO₂ layer and the Au layer, and the Au layer is detached later.

The separation layer system 15 comprises at least two layers—an SiO₂ layer and an Au layer, wherein the reflector layer 8 is deposited on the latter in the form of the ruthenium layer. According to one possible embodiment, the mold body 21 is made, for example, from Ni-P. Then, in a first method step according to FIG. 4c, SiO₂ is vapor-deposited onto the outer periphery 22 of the mold body 21. This layer can be maintained for a plurality of molding procedures.

FIG. 4a illustrates, in a schematically simplified representation, the basic construction of the arrangement for molding the individual layers. The latter comprises the mold body 21 and an evaporating device 26 assigned thereto. Mounting a mold body 21 coated in this way in air or under ambient conditions can lead to a change in the adhesion forces and thus influence the molding process overall. In a further, second method step, an Au layer is deposited on the SiO₂ layer, for example vapor-deposited, followed by the ruthenium layer which functions, according to the invention, as the reflector layer 8. Subsequently, the mold body 21 with the previously applied layers of the separation layer system 15 and the later layer system 7 and the layer for the base body 4 of the collector shell 1 is plated by electroforming, preferably with an electrochemical process and preferably a galvanic process, directly onto the ruthenium layer, or nickel-plated. The molded layer system 23 therefore consists, according to FIG. 4b of “mold body 21 Ni-P//SiO₂/Au/Ru/galvanic Ni.” Thereafter separation into the mold body 21 and a shell 25 for a grazing-incidence collector takes place. The separation is carried out, in the Au/SiO₂ system, between the SiO₂ and the Au. The molding is therefore carried out indirectly via an intermediate layer in the form of Au. The Au layer is then removed from the reflector layer in the subsequent method step. This is preferably carried out by chemical means. The galvanic Ni comprises the base layer and thus the base body 4. The detachment process for the Au layer is dependent on the solvent used therein and on the process parameters for detachment, and therefore the duration or soak time, and temperature. For ruthenium-coated collector shells 1 of the aforementioned size, these are in the range of 4 minutes to 10 minutes at room temperature. Aside from the removal of the Au residues, these process parameters also determine the micro-roughness of the surface 6.

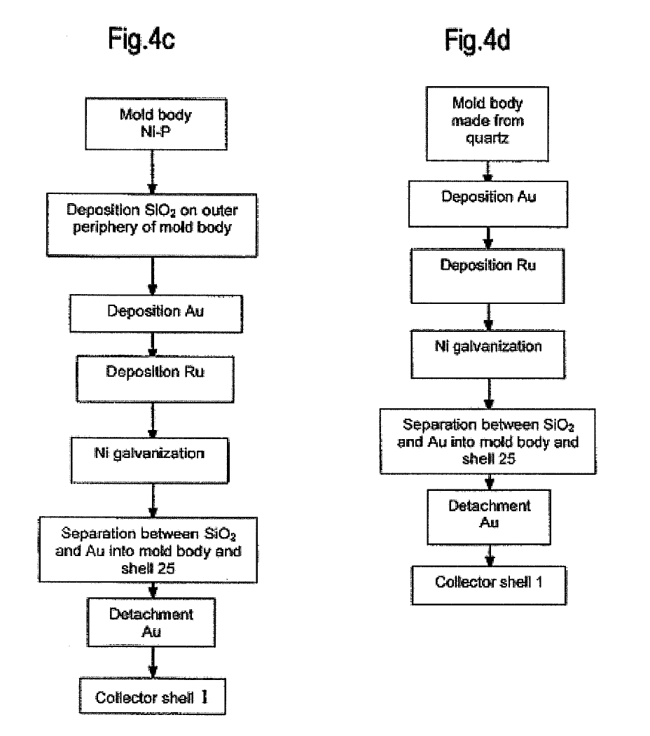

FIG. 5 illustrates with a graphical representation the dependence of micro-roughness on the process parameters temperature and immersion time at the surface. It is evident therefrom that significant deviations can arise herein. With additional spectral reflection measurements at a wavelength of between 200 nm and 1000 nm, it is possible to distinguish clearly between an Au surface and an Ru surface.

FIG. 4d illustrates, in the form of a flow-diagram, the molding process where the mold body 21 is made from quartz. In this case, the SiO₂ coating can be dispensed with, wherein in this case the surface of the mold body must be polished to produce a sufficiently low micro-roughness.

With the process steps illustrated in FIGS. 4c and 4d, molding processes can be carried out with reflector layer thicknesses D8 up to 1020 nm ruthenium without difficulty. The layer tension values produced thereby are low enough to permit molding without layer crack formation and layer detachment. Compared with molding, mechanically more stable layers are obtained with ion-supported coating processes.

For the separation layer system 15, the following layer thicknesses are selected for the individual layers:

SiO₂ in the range of 50 nm to 200 nm, preferably 100 nm

Au in the range of 100 nm to 300 nm, preferably 200 nm

Ru in the range of 10 nm to 150 nm, preferably 10 nm to 120 nm

The adhesion forces between the individual layers, in particular between SiO₂ and Au, can be varied within limits by storage or ageing of the mold body 21, plasma surface treatment in the deposition system and by deposition without prior ventilation.

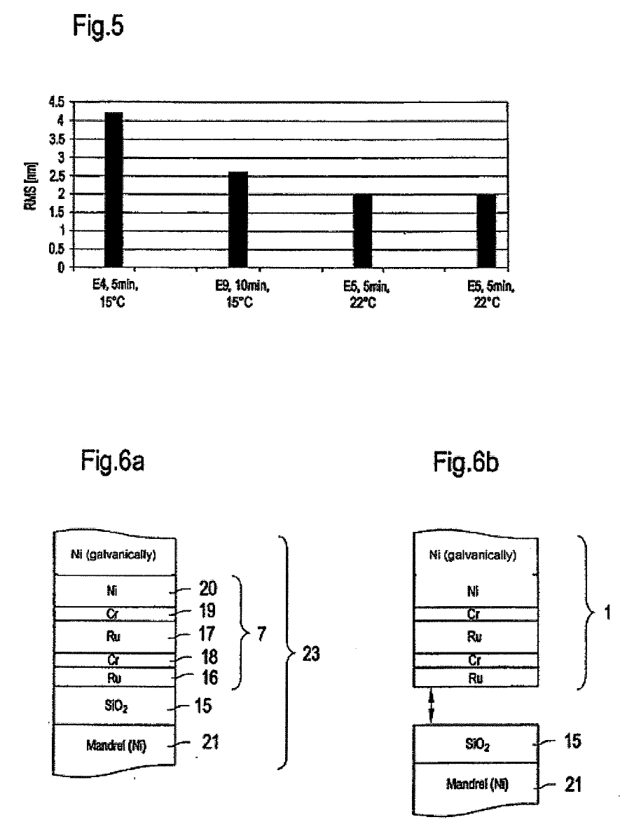

FIG. 6 illustrates a molding method for producing a second embodiment of a collector shell of a grazing-incidence collector according to FIG. 3. FIG. 6a illustrates the mold body coating with the separation layer system 15 and the layer system 7 of the collector shell 1. According to the invention, a molded layer system 23 is herein formed from the following layers:

Mold body Ni-P//SiO₂/Ru/Cr/Ru/Cr/Ni/galvanic Ni.

FIG. 6b illustrates the layer structure after separation.

In order to achieve moderate adhesion forces which are suitable for molding, a layer of SiO₂ is applied to the mold body made from Ni-P. After the SiO₂ deposition, there is an interruption during which the surface 22 of the mold body 21 is subjected to treatment for a particular duration. The layer system is thereby conditioned and a reduction or optimization of the adhesion forces between the SiO₂ and the Ru layer is undertaken. Subsequently, the further layers are vapor-deposited as described above. Firstly, a first Ru layer 16 is vapor-deposited without ion-support in order to prevent excessively high forces. Firing Ar ions from the ion source would change the conditioning of the SiO₂ layer and strongly increase the adhesion forces. Improved binding to the second Ru layer 17 is achieved with a Cr seed layer. In order to prepare for the subsequent Ni galvanizing, an Ni layer is subsequently vapor-deposited with a Cr seed layer. The coated mold body is then removed from the vapor-deposition system and subjected to electroforming by an electrochemical process. This is followed by separation into the mold body and the collector shell 1.

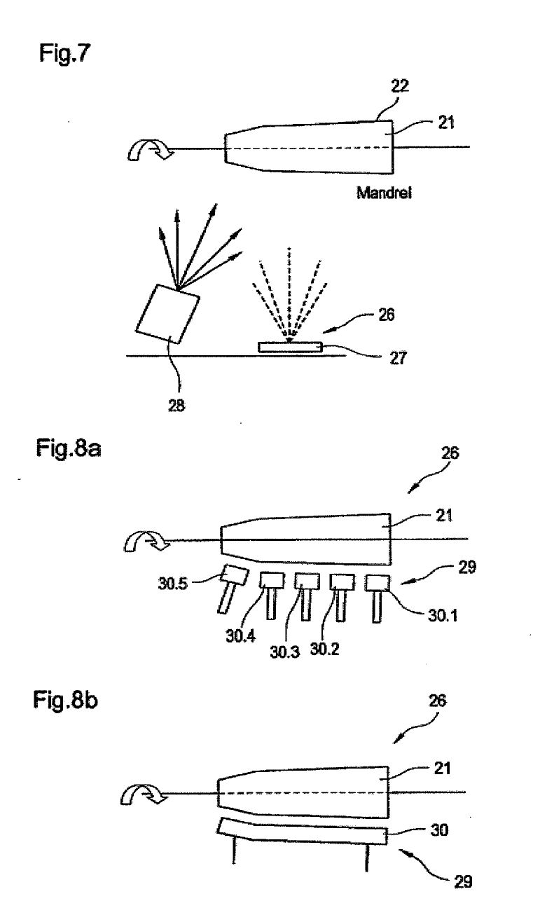

FIG. 7 makes clear, in a schematically simplified representation, the structure of the vapor-deposition device 26. Shown therein is an evaporation device, in the form of an electron beam evaporator 27, and the ion source 28.

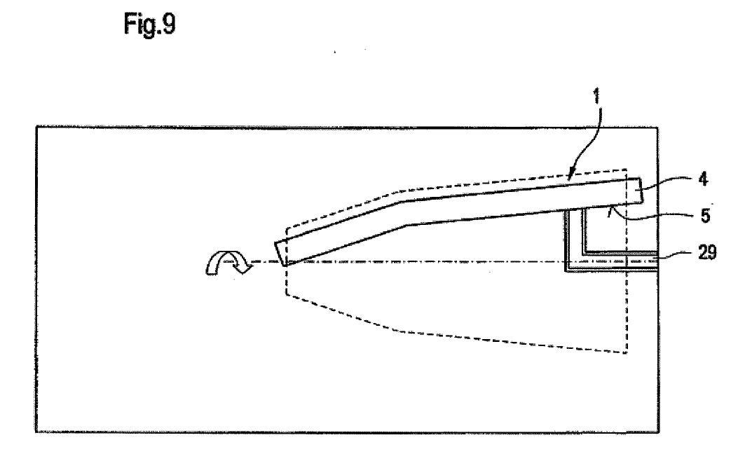

In the method shown in FIGS. 4 to 7, the application of the individual layers is carried out by vapor-deposition. This is carried out with known PVD methods, for example, thermal evaporation, evaporation with electron beam evaporators or sputtering, in particular magnetron sputtering. The arrangement for sputtering is shown in FIG. 8 in a schematically simplified form. A sputtering device 29 is assigned to the rotatably mounted and drivable mold body 21. This comprises at least one source 30 according to FIG. 8b, preferably a plurality of sources 30.1 to 30.5 according to FIG. 8a. These are installed parallel to the surface 22 in order to ensure as homogeneous a layer thickness distribution as possible during vapor-deposition.

The embodiment according to FIG. 8b shows the use of a source 30 which has a suitably formed active region 31 which covers the mold body 21 in the axial direction over part of its extent.

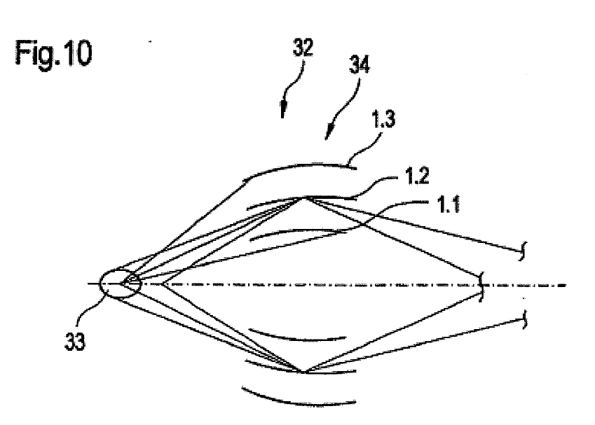

FIG. 9, by contrast, illustrates an arrangement for producing the collector shell 1 according to an alternative method which is characterized by molding the base body 4 and the independently performed and temporally offset coating with the coating system according to the first and second embodiments. The coating is carried out by sputtering of the reflector layer onto the inner surface 5 of the base body 4 of the collector shell 1 by means of a sputtering device 29. The sputtering device is preferably configured so that the entire inner surface can be sputtered in one operation simultaneously.

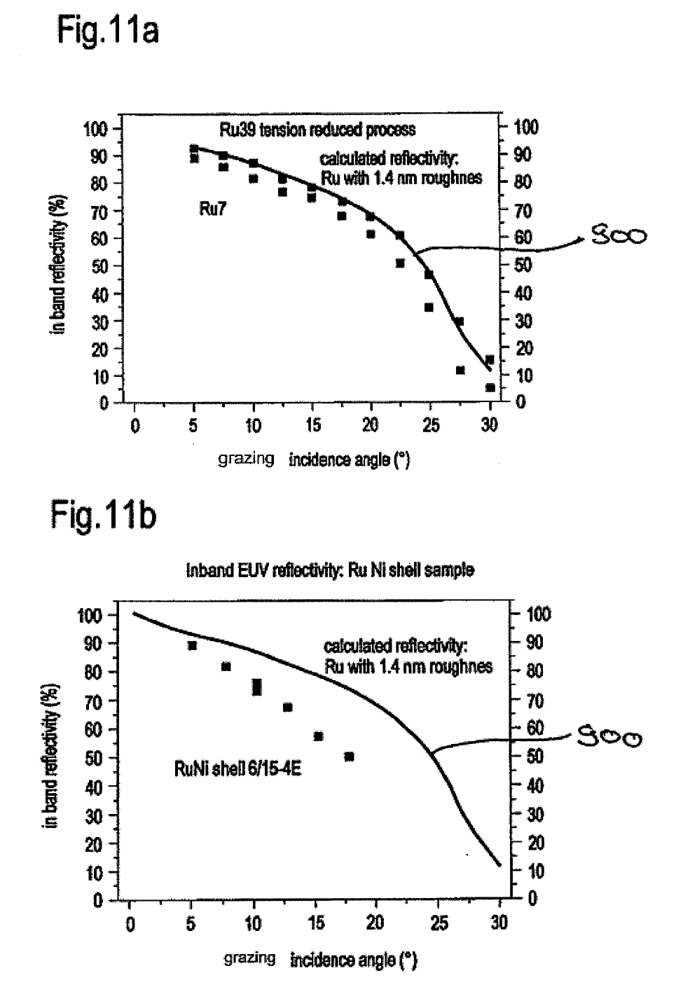

FIG. 10 illustrates a section of an illumination system 32. This comprises a light source 33 the light from which is received by a collector 34. In the embodiment shown, the schematically illustrated collector 34 comprises a total of three mirror shells 1.1, 1.2, 1.3 arranged within one another, which receive the light from the light source 33 at grazing incidence and form it into an image of the light source. The mirror shells 1.1, 1.2, 1.3 of the collector can be made according to the inventive molding method.

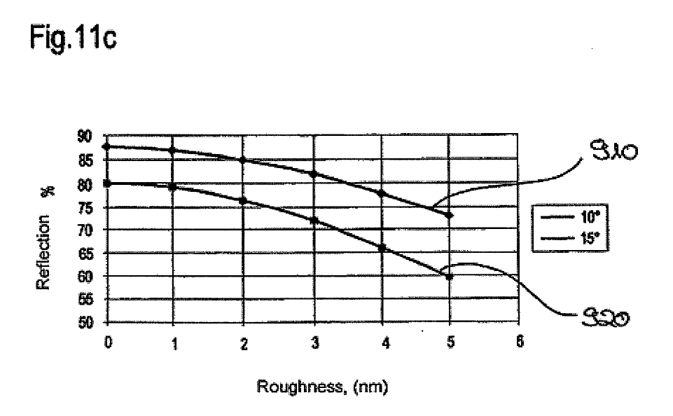

The collector shell 1 coated according to the invention is also characterized by its roughness. FIG. 11 a illustrates the calculated reflection 900 for Ru for a roughness of 1.4 nm and the measured reflection (“in-band reflectivity”(%)) for Ru vapor-deposited onto an SiO₂ substrate with an Ni intermediate layer, as a function of angle of incidence (grazing-incidence angle) relative to a tangent to the surface at a wavelength of 13 nm.

FIG. 1 lb illustrates the calculated reflection for Ru for a roughness of 1.4 nm and the measured reflection for Ru vapor-deposited onto an SiO₂ substrate with a Cr adhesion layer as a function of angle of incidence relative to a tangent to the surface at a wavelength of 13 nm.

From the angles of incidence given in FIGS. 11a and 11b, angles of incidence relative to the normal are calculated as follows:
angle of incidence relative to the normal=90°—angle of incidence relative to the tangent to the surface

As FIGS. 11a and 11b show, in the range of angles of incidence between 10° and 15° relative to a tangent to the surface, a reflection of between 60% and 75% is produced for the layer system substrate//Ni/Ru and between 75% and 80% for the layer system substrate//Cr/Ru. For the layer system (SiO₂-substrate//Cr/Ru) in FIG. 11b, a roughness of approximately 0.6-0.8 nm RMS is measured on the AFM, which corresponds well to the calculated roughness of 1.4 nm. However, the roughness of the substrate must also be taken into account. The molded shells have AFM roughnesses in the range of 1 nm to 2 nm RMS. FIG. 11c illustrates the calculated reflection depending on the roughness at angles of incidence tangential to the surface, i.e., relative to a tangent to the surface, of 10° (reference sign 910) and 15° (reference sign 920).

It is clear that the reflectivity or the reflection in % decreases the larger the roughness of the surface is. For example, at a roughness of 5 nm and an angle of incidence of 15° tangential to the surface, the reflectivity is only 60%.

Furthermore, it is clear from FIG. 11c that as the angle of incidence increases, the reflectivity decreases.

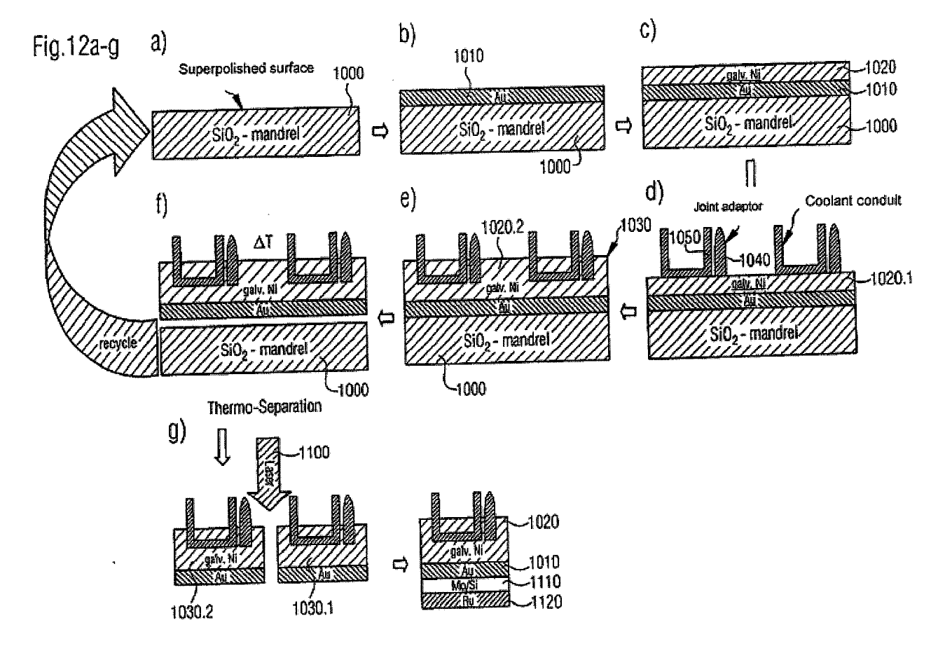

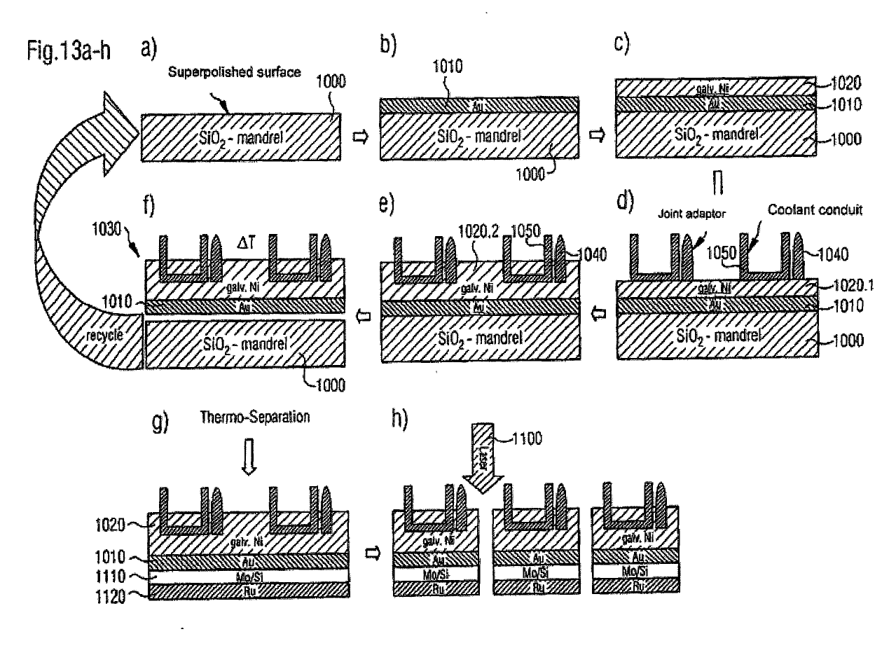

FIGS. 12a to 12g, 13a to 13h and 14a to 14h illustrate three methods for producing normal-incidence elements, in particular reflective normal-incidence mirrors or facets for a faceted optical element with the aid of molding techniques. With a method according to FIGS. 12a to 12g and FIGS. 13a to 13h, in principle, a metal layer, for example an Au layer, is applied to a mold body 1000, which can also be configured as a SiO₂ mold body.

The mold body 1000 can be made from quartz glass (SiO₂) or Kanigenized aluminum. The surface roughness of the mold body is adjusted or reduced, for example, by superpolishing, to values which correspond to those needed in the EUV wavelength range for a normal-incidence mirror coated with a multiple-layer system in order to make a high reflectivity available, for example in the region of 70% of the incident radiation. Preferably, the superpolishing of the mold body is undertaken so that 0.1 nm to 1 nm HSFR is achieved at spatial frequencies in the range of 10 nm to several micrometers.

As shown in FIGS. 12b and 13b, the mold body 1000 is then coated with a separation layer 1010, for example an Au layer the thickness of which can preferably be in the range of 50 nm to 200 nm. In step 12c or 13c, a metal layer 1020, for example, an Ni layer is galvanically deposited on the gold layer. The Au layer serves therein as the cathode.

Preferably, the deposition of the metal by galvanic means, as shown in FIGS. 12c to 12e and 13c to 13e, takes place in at least two steps. This enables a base body 1030 for a normal-incidence mirror to be provided by galvanic deposition, into which mechanical components such as joint adaptors 1040 or cooling components 1050 such as coolant pipes can be introduced. To this end, initially a first layer 1020.1 is applied to the Au layer 1010 as shown in step 12c or 13c. Then the coolant elements 1050, for example cooling pipes or joint elements 1040, are placed on the galvanically deposited Ni layer 1020.1. This is shown in FIGS. 12d and 13d. Once the mechanical components and the coolant components have been placed on the first layer, a metal, for example, Ni, is further deposited by galvanic means, producing a second layer 1020.2. The first layer 1020.1 has a thickness in the range of 0.2 mm to 0.8 mm, preferably 0.5 mm and the second layer 1020.2, which is deposited according to FIGS. 12e and 13e, has a thickness in the range of 1 mm to 4 mm. As shown in FIGS. 12e and 13e, the cooling element or the mechanical element is firmly embedded in the metal layer of the base body, in this case the Ni layer, in material-fitting manner, so that a particularly low thermal conduction resistance can be ensured.

In place of Ni, Cu can also be used for the galvanic deposition. Naturally, the method can also comprise more than two steps.

As shown in FIGS. 12f and 13f, the system comprising the base body 1030 made from a metal material, specifically galvanized nickel together with the separation layer 1010 which is made here from Au, is separated from the mold body 1000 by thermoseparation. The thermoseparation is based on a temperature shock or a sudden temperature change to lower temperatures. Due to the different coefficients of thermal expansion between the mold body 1000 and the metal applied thereto, the metal and the mold body become separated as soon as the thermally induced tensions exceed the adhesion tensions between the metal and the mold body. Gold Au is a particularly good separation system, since the gold Au remains on the separated metal layer of, for example, Ni or Cu. The molding technique also transfers the roughness of the mold body 1000 to the molded base body 1030. It is thus of decisive importance that the surface of the mold body already has the properties of the later normal-incidence mirror. In place of Au, ruthenium Ru could also be used as the separation layer system.

Once the base body 1030 of a normal-incidence optical element provided with cooling elements and joint adaptors, as per FIG. 12, has been separated from the mold body by thermoseparation, with the aid of a laser 1100, the metal body can be separated into individual base bodies 1030.1, 1030.2.

The individual base bodies can then serve as the base for the coating of different normal-incidence elements, for example, the individual facets for a faceted optical element.

In contrast to FIG. 12g, separation of the metal base body during the method according to FIG. 13g does not take place before the coating with a multiple-layer system, but only thereafter. The difference of the method in FIGS. 12a to 12g is therefore that, in the method according to FIGS. 12a to 12g, after separation of the metal body from the mold body, said metal body is separated into individual bodies and the individual bodies are then coated with an Mo/Si multiple-layer system as usual for normal-incidence optical elements and this guarantees high reflectivities. The Mo/Si multiple-layer system 1110 is then provided with an Ru cover layer 1120 in order to prevent degradation in particular of the multiple-layer system during operation, for example, in an EUV projection illumination system. Mo/Si multiple-layer systems are used in normal-incidence optical elements, preferably in systems such as microlithography projection illumination systems which have an operating wavelength of approximately 13 nm. For systems with an operating wavelength of approximately 11 nm, Mo/Be systems are preferably used.

The reflectivity of an optical element coated with, for example, an Mo/Si multiple-layer system is approximately 70% at an operating wavelength of approximately 13 nm. Reference is made, for example, to U.S. Pat. No. 6,600,552, the disclosure of which is included in the present application.

In the method according to FIGS. 13g to 13h, after separation of the metal body in FIG. 13f from the mold body, the metal body is coated in a multiple-layer system 1110. Following coating, separation into different components is carried out. The advantage of the method according to FIG. 13g is that the coating can be carried out in a single coating chamber. The same components as shown in FIGS. 12a to 12f are identified in FIGS. 13a to 13f with the same reference signs.

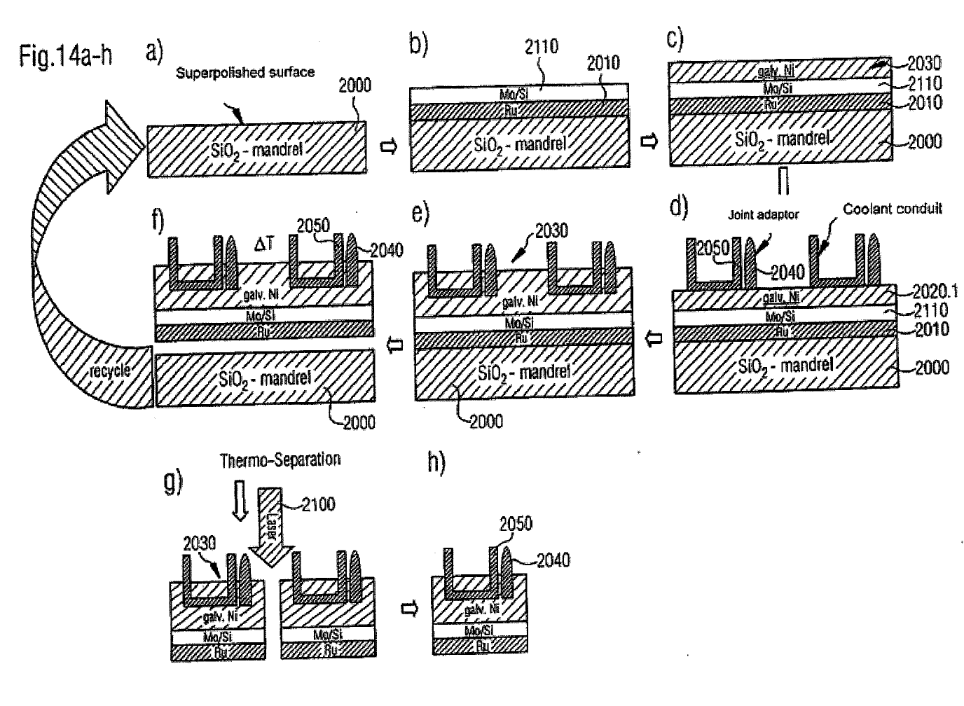

In FIGS. 14a to 14h, an alternative method is shown with which, using molding techniques, a normal-incidence mirror can be made with a minimum of effort. The same components as shown in FIGS. 12a to 12f and 13a to 13f are identified with reference signs that are increased by 1000. As described in the method according to FIGS. 12a to 12g and 13a to 13h, a separation layer 2010, in this case an Ru layer, is applied to a mold body 2000 with the aid of vapor-deposition methods, as shown in FIG. 14b. Thereafter, the complete multiple-layer system 2110 comprising Mo/Si multiple layers or Mo/Be multiple layers is deposited onto the Ru layer, which is used as the separation layer 2010.

With the aid of a galvanic deposition method, a metal, for example, Ni, is then applied to a conductive layer, for example, a molybdenum layer of the Mo/Si multiple-layer system or Mo/Be multiple-layer system 2110 which acts as a cathode. In place of or in addition to the molybdenum layer, a metal layer deposited on the multiple-layer system, for example, an Au layer or an Ni layer can function as the cathode. The steps 14d to 14f correspond to the steps 12d to 12f or 13d to 13f.

Once the base body 2030 has been grown from galvanized nickel onto the multiple-layer system 2110, during which the cooling channels 2050 and any joints 2040 have been introduced into the metal layer, the entire normal-incidence optical element with the multiple-layer system 2110 and the Ru cover layer is separated from the mold body 2000 using thermoseparation as described above. In a further step, the normal-incidence element, for example, a facet of a faceted optical element is separated into different individual elements, for example, with a laser.

Using the molding technique according to the invention, a normal-incidence optical element, for example a mirror, is provided wherein the base body is made from a metal. This has the advantage that the electrostatic charge, for example, in a vacuum chamber of a microlithography system can be reduced, since electrons can be conducted away via the metallic base body.

Furthermore, in a preferred embodiment, the optical element according to the invention is characterized in that cooling conduits can easily be introduced into the base body, which serves as a support for the reflective layers of the mirror system. In particular, these cooling conduits are introduced integrally into the base body and not additionally mounted as, for example, in the grazing-incidence element disclosed in WO 02/065482. In the system according to WO 02/065482, separate cooling plates which can be permeated by cooling conduits are connected to the mirror shell of a collector.

In contrast thereto, with the optical element according to the invention, in particular the normal-incidence optical element, the cooling conduit is introduced directly into the base body and is an integral component thereof.

With the invention, a method is therefore provided with which it is additionally possible using molding techniques to produce optical elements for microlithographic applications. In addition, optical elements for microlithography having metal base bodies, specifically both normal-incidence elements and grazing-incidence elements are provided.

With the method according to the invention, normal-incidence optical elements can be used, for example, normal-incidence facets in faceted optical elements of an illumination system for a microlithography projection illumination system. In this connection, reference is made to U.S. Pat. No. 6,198,793 B1, U.S. Pat. No. 6,658,084 or WO 2005/015314 A2, the disclosurs of which are incorporated in their entirety into this application.

FIG. 6a in U.S. Pat. No. 6,658,084 shows a faceted optical element, designated a field faceted mirror or a field raster element plate, with a plurality of individual field facets or field raster elements. The individual field facets or field raster elements of the field facet mirror disclosed in U.S. Pat. No. 6,658,084 can be produced as normal-incidence optical elements using the method described in this application. In particular, with the method according to the invention, each individual field facet or each individual field raster element of the field raster element plate can be provided with cooling channels or mechanical elements such as joints, for example, actuators. Naturally, the individual pupil facets or pupil raster elements of the pupil raster plate shown in FIGS. 6b1 to 6b2 in U.S. Pat. No. 6,658,084 can also be produced as normal-incidence optical elements according to the inventive method and so provided with cooling channels or mechanical elements.

Furthermore, it is possible to produce all the optical elements in the light path of a microlithography projection illumination system, as disclosed, for example, in FIG. 10 of U.S. Pat. No. 6,658,084 or FIG. 12 of WO 2005/015314, according to the inventive method. In particular, it is also possible to produce the normal-incidence collector mirror shown in FIG. 10 of U.S. Pat. No. 6,658,084 or the nested grazing-incidence collector shown in FIG. 12 of WO 2005/015314 and comprising a plurality of collector shells using a molding method according to the invention.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. A method for producing at least a part of an optical element having a base body, comprising:
providing a mold body with a surface which corresponds to the geometry of the optical element;
reducing a surface roughness of the mold body by super-polishing the mold body;
depositing a layer system comprising at least one separation layer system on the surface of the mold body;
electroforming a base body on the layer system; and
detaching at least the base body at the separation layer system from the mold body.

2. The method as claimed in claim 1, wherein the layer system comprises at least one reflector layer and the at least one reflector layer is deposited on the separation layer system, and wherein the electroforming of the base body takes place on the at least one reflector layer.

3. The method as claimed in claim 2, wherein the at least one reflector layer is part of a multiple-layer system.

4. The method as claimed in claim 3, wherein the multiple-layer system is a sequence of Mo/Si layers or Mo/Be layers.

5. The method as claimed in claim 3, wherein the separation layer system comprises Au or Ru.

6. The method as claimed in claim 2, wherein the at least one reflector layer comprises Ru.

7. The method as claimed in claim 6, wherein the separation layer system is configured as a multiple-layer system and comprises an SiO₂ layer deposited on the mold body and an Au layer deposited on the SiO₂ layer, and wherein said detaching from the mold body takes place between the SiO₂ layer and the Au layer in the separation layer system.

8. The method as claimed in claim 1, further comprising, following said detaching of the base body, which forms a part of the optical element, depositing a reflector layer onto the base body or onto the base body with the separation layer system.

9. The method as claimed in claim 8, wherein the at least one reflector layer is part of a multiple-layer system.

10. The method as claimed in claim 9, wherein the multiple-layer system is a sequence of Mo/Si layers or Mo/Be layers.

11. The method as claimed in claim 9, wherein the separation layer system comprises Au or Ru.

12. The method as claimed in claim 8, wherein the reflector layer system comprises Ru.

13. The method as claimed in claim 1, wherein said electroforming of the base body comprises a first electroforming step and a second electroforming step, and further comprising, between the first and the second electroforming step, arranging at least one of cooling devices and joint devices on a first layer of the base body.

14. The method as claimed in claim 13, wherein the first electroforming step produces a first layer of the base body, and, in the second electroforming step, a second layer is deposited on the first layer of the base body, so as to embed the at least one of the cooling devices and joint devices into the base body.

15. The method as claimed in claim 1, wherein the base body comprises a metal selected from the group consisting of: Ni, Cu, and Ni alloys.

16. The method as claimed in claim 1, wherein the mold body comprises quartz glass (SiO₂) or Kanigenized aluminum.

17. The method as claimed in claim 1, further comprising:
depositing a layer of SiO₂ on the surface of the mold body; and
following said depositing of the SiO₂ layer on the mold body, subjecting the SiO₂ layer to surface treatment for a predetermined duration.

18. The method as claimed in claim 1, wherein the mold body comprises quartz glass or has a layer of SiO₂ deposited thereon, and further comprising depositing alternating layers of ruthenium and adhesion layers made from Cr on the SiO₂ layer or the quartz glass.

19. The method as claimed in claim 1, further comprising depositing a reflector layer on the base body in a vacuum or in an electrochemical environment.

20. A method for producing a normal-incidence optical element, comprising:
super-polishing a mold body with a surface which corresponds to the geometry of the normal-incidence optical element;
electroforming a base body on the mold body;
detaching the base body from the mold body; and
depositing a layer system comprising at least one reflector layer on the surface of the base body.

21. The method as claimed in claim 20, further comprising providing a separation layer system which comprises at least one metal layer deposited on the mold body.

22. The method as claimed in claim 20, wherein said depositing of layers of the layer system comprises vapor-deposition.

23. The method as claimed in claim 20, wherein the at least one reflector layer is part of a multiple-layer system and the multiple-layer system is a sequence of Mo/Si layers or Mo/Be layers.

24. The method as claimed in claim 20, wherein the reflector layer comprises at least one Ru layer.

25. The method as claimed in claim 20, wherein said electroforming of the base body comprises a first electroforming step and a second electroforming step, and further comprising, between the first and the second electroforming step, arranging at least one of cooling devices and joint devices on a first layer of the base body.

26. The method as claimed in claim 25, wherein the first electroforming step produces a first layer of the base body, and, in the second electroforming step, a second layer is deposited on the first layer of the base body, to embed the at least one of the cooling devices and joint devices into the base body.

27. The method as claimed in claim 20, wherein the base body comprises a metal selected from the group consisting of: Ni, Cu, and Ni alloys.

28. A normal-incidence optical element, comprising a base body and at least one reflector layer deposited on the base body, wherein the base body consists of a metal.

29. The normal-incidence optical element as claimed in claim 28, wherein the at least one reflector layer is part of a multiple-layer system, and wherein the multiple-layer system comprises Mo/Si layers or Mo/Be layers.

30. The normal-incidence optical element as claimed in claim 28, wherein the at least one reflector layer comprises an Ru layer.

31. The normal-incidence optical element as claimed in claim 28, wherein the base body comprises a metal selected from the group consisting of: Cu, Ni, and Ni alloys.

32. A normal-incidence optical element, comprising a base body and at least one of cooling devices and joint devices embedded in the base body.

33. The normal-incidence optical element as claimed in claim 32, wherein the base body comprises at least a first layer and a second layer, and wherein the least one of the cooling devices and the joint devices are embedded between the first layer and the second layer.
